(19) United States
(12) Patent Application Publication
(10) Pub. No.: US 2020/0032788 A1
(43) Pub. Date: Jan. 30, 2020

(54) Piston Pump And Method For Determining Volume Delivered By Piston Pump

(71) Applicant: Robatech AG, Muri (CH)

(72) Inventors: Urs Mösli, Winterthur (CH); Hanspeter Felix, Zofingen (CH); Andreas Hofer, Umiken (CH)

(73) Assignee: Robatech AG, Muri (CH)

(21) Appl. No.: 16/517,567

(22) Filed: Jul. 20, 2019

(30) Foreign Application Priority Data
Jul. 24, 2018 (EP) 18185230.2

(51) Int. Cl. F04B 53/10; F04B 53/16; G01F 22/00

(52) U.S. Cl. CPC F04B 53/10; F04B 2205/16; G01F 22/00; F04B 53/16

(57) ABSTRACT

A piston pump and a method for determining a volume V_{eff} of a liquid medium delivered to a consumer by a double acting, pneumatically driven piston pump, wherein the piston pump is subject to leakage when a constant pressure is acting on a drive of the piston pump and at least one double stroke of a piston pump from one dead center position thereof to the other dead center position thereof and back to the first dead center position is carried out includes:
a. without the piston pump being able to deliver the medium to the consumer, a leakage time t_{L auf} for one stroke of the piston pump from the bottom dead center position thereof to the top dead center position thereof is measured,
b. without the piston pump being able to deliver the medium to the consumer, a leakage time t_{L ab} for one stroke of the piston pump from the top dead center position thereof to the bottom dead center position thereof is measured,
c. a quotient of a volume of the medium V_{auf} theoretically delivered by the piston pump without leakage and of the leakage time t_{L auf} is determined for the stroke of the piston pump from the bottom dead center position to the top dead center position,
d. a quotient of a volume V_{ab} theoretically delivered by the piston pump without leakage and of the leakage time t_{L ab} is determined for the stroke of the piston pump from the top dead center position to the bottom dead center position,
e. the time t_{auf} for the stroke of the piston pump from the bottom dead center position to the top dead center position and the time t_{ab} for the stroke of the piston pump from the top dead center position to the bottom dead center position is measured as the medium is delivered to the consumer,
f. the effectively delivered volume V_{eff} is multiplied by the number of double strokes in accordance with

$${V}_{eff} = ( {V}_{auf} - \frac{{V}_{auf}}{{t}_{L auf}} \times {t}_{auf} ) + ( {V}_{ab} - \frac{{V}_{ab}}{{t}_{L ab}} \times {t}_{ab} ) .$$

### FIELD OF THE INVENTION

The invention relates to a piston pump and a method for determining a volume of a liquid medium, in particular a heated adhesive, effectively delivered to a consumer by a double acting, pneumatically driven piston pump.

### BACKGROUND AND RELATED ART

In the field of applying adhesives, especially the field of delivering viscous hot melt adhesives, there is a desire to know the applied quantity of adhesive as precisely as possible. It should be possible to determine, if possible for each product, whether the correct quantity of adhesive has been applied. From this, it is possible to derive statistical information, trend indications and assessments as to whether the products are being produced to the required quality. In the case of many products, the applied quantity of adhesive is very small, and therefore these judgments cannot be applied to each single individual product processed but only to an average of a number of products. This results in the requirement that the accuracy of a measured adhesive volume flow or mass flow should be better than approximately ±7%.

WO 2016/010597 A1 discloses a device for determining the output of a delivery volume of a heated adhesive, wherein this device has a double acting, pneumatically driven piston pump. To detect the delivery volume of the piston pump, a position sensor for a piston rod of the piston pump is provided. The delivery volume is therefore calculated on the basis of a knowledge of the respective piston position.

EP 2 732 884 A2 discloses an adhesive output system and a method relating thereto. The system has a diagnostic module, which serves inter alia to determine the volume flow output by the pump. A leakage test is used to test the leak tightness of the pump. The pump is a double acting, pneumatically driven piston pump.

EP 1 907 806 B1 describes a reciprocating piston pump having an electronically monitored air valve and piston. The pump comprises a piston and furthermore a sensor for detecting the position of the piston.

A piston pump is a pump which, on the basis of its construction, provides volumetric delivery. In practice, use is made of double acting, pneumatically driven piston pumps in which there is intentionally a certain leakage between the piston and the cylinder, and the guide of the piston rod adjoining the pressure chamber of the piston pump is also not embodied to form a seal.

To be able to deliver a volume flow of the liquid medium, in particular of the heated adhesive, which is as continuous as possible, the piston pump delivers in both stroke directions of the piston. This is a double acting piston pump. To make this possible, there are two check valves, which do not have identical designs. During the reversal process at the bottom and top dead center positions of the piston, during the actuation of the check valves, there is a slight loss of volume flow. The magnitude of this loss differs at the top and the bottom dead center position. In particular, this loss is dependent on the viscosity and flow properties of the liquid medium or the adhesive used.

In order to minimize wear, avoid maintenance work and achieve a service life which is as long as possible, the piston of the pump is not embodied to form a seal. A certain leakage therefore occurs between the piston and the cylinder. This leakage is dependent, in particular, on the viscosity and flow behavior of the liquid medium/liquid adhesive, on the size of the annular gap around the piston and on the speed of the piston movement.

The guide of the piston rod adjoining the pressure chamber is likewise not embodied to form a seal. A certain leakage occurs between the piston rod and the guide. This leakage volume flow is preferably guided back into a tank/adhesive tank. This leakage is dependent, in particular, on the viscosity and flow behavior of the liquid medium/liquid adhesive, on the size of the annular gap around the piston rod and on the speed of the stroke movement, and furthermore on the consumption of liquid medium/liquid adhesive, or on how many valves of application devices are currently open.

The speed of the piston is determined, in particular, by the pressure of the compressed air which acts on the drive of the piston pump.

Normally, the piston pump does not have a device for determining the piston position. Only at the changeover positions are there sensors which control the drive of the piston pump and bring about a changeover of the stroke direction. In principle, the piston position can be detected by two Hall effect sensors.

For the user of the piston pump, it is important to know the discharged mass of liquid medium or applied mass of adhesive per product.

### OBJECT AND SUMMARY OF THE INVENTION

It is the object of the present invention to provide a piston pump and a method for the precise determination of a volume effectively delivered to a consumer by a double acting, pneumatically driven piston pump subject to leakage. As used herein, the term “consumer” is intended to refer generically to adhesive application equipment that receives the adhesive, for example, an adhesive applicator module, adhesive dispenser, applicator nozzle or the like. It is furthermore the object of the invention to provide an advantageously designed piston pump for carrying out the method.

The object is achieved by a double acting pneumatically driven piston pump and a method according to the appended claims.

The invention proposes a method for determining a volume flow V_{eff} of a liquid medium, in particular a heated adhesive, effectively delivered to a consumer by a double acting, pneumatically driven piston pump, wherein the piston pump is subject to leakage, having the following features when a constant pressure is acting on a drive of the piston pump and at least one double stroke of a piston pump from one dead center position thereof to the other dead center position thereof and back to the first dead center position is carried out:
a. without the piston pump being able to deliver the medium to the consumer, a leakage time t_{L auf} for one stroke of the piston pump from the bottom dead center position thereof to the top dead center position thereof is measured,
b. without the piston pump being able to deliver the medium to the consumer, a leakage time t_{L ab} for one stroke of the piston pump from the top dead center position thereof to the bottom dead center position thereof is measured,
c. a quotient of a volume of the medium V_{auf} theoretically delivered by the piston pump without leakage and of the leakage time t_{L auf} is determined for the stroke of the piston pump from the bottom dead center position to the top dead center position,
d. a quotient of a volume V_{ab} theoretically delivered by the piston pump without leakage and of the leakage time t_{L ab} is determined for the stroke of the piston pump from the top dead center position to the bottom dead center position,
e. the time t_{auf} for the stroke of the piston pump from the bottom dead center position to the top dead center position and the time t_{ab} for the stroke of the piston pump from the top dead center position to the bottom dead center position is measured as the medium is delivered to the consumer,
f. the effectively delivered volume V_{eff} is multiplied by the number of double strokes in accordance with

$${V}_{eff} = ( {V}_{auf} - \frac{{V}_{auf}}{{t}_{L auf}} \times {t}_{auf} ) + ( {V}_{ab} - \frac{{V}_{ab}}{{t}_{L ab}} \times {t}_{ab} )$$

Thus, in the method, the leakage time, as a physical variable that is simple to determine, is determined under the same operating conditions in which production is subsequently to take place. Based on the use of the method with a heated adhesive, the most important operating conditions are the type of adhesive, the adhesive temperature and the pressure of the compressed air for driving the piston pump.

Since the double acting, pneumatically driven piston pump is subject to leakage, with the piston of the pump and the check valves, in particular, forming a certain leakage, the piston pump always moves slightly in the standby state, even without consumption of the liquid medium/liquid adhesive. In order to take account of all the losses, the time during which the piston pump carries out one or more complete double strokes is measured. This leakage time is used, together with the pressure of the air, to calculate the effective leakage. One advantage is that the leakage time can be determined without the need to deliver liquid medium/liquid adhesive and hence without losing any liquid medium/liquid adhesive. The leakage time is thus the time which expires until the piston pump in the standby state has carried out one or more complete double strokes without discharging liquid medium/liquid adhesive.

The leakage time of the double stroke is split into the time for the upward stroke (movement of the piston from the bottom dead center position to the top dead center position) and the time for the downward stroke (movement of the piston from the top dead center position to the bottom dead center position). The times for the two stroke movements are different in magnitude. The effectively delivered volume for each stroke direction can be calculated in a simple manner by means of linear relationships, using these two times.

Apart from determination of the effectively delivered volume of the piston pump subject to leakage, it is often relevant in practice also to know a mass of the liquid medium output by the piston pump, more specifically the applied mass of adhesive per product. The mass is preferably determined in two steps. First of all, the calculated leakage is used to determine the volume of liquid medium, in particular the volume of adhesive, delivered per unit time and the number of products processed. In a second step, the mass is determined with a previously determined density of the liquid medium/liquid adhesive. It is thus necessary to determine information on the leakage and density before the mass delivered can be calculated.

It has been found that there are two simple methods which must be carried out before the calculation can take place. On the one hand, the leakage time described above must be determined. On the other hand, the density of the liquid medium/liquid adhesive must be determined.

Particularly when using liquid adhesive, the density thereof is dependent on the temperature of the adhesive and on the type of adhesive. The effectively delivered volume is dependent on the manufacturing tolerances of the piston pump and, at the very least, on any existing wear. In order to be able to take this into account, adhesive is delivered during a largely freely selectable period of time, which should encompass several complete stroke cycles of the piston pump, and, at the same time, the quantity is calculated in accordance with the method described here. In order to be able to calculate the quantity in a specific case, the leakage time must be measured first. The adhesive delivered is collected and weighed. After the input of the mass delivered, a correction factor can be determined, which is used to calibrate the calculation. This correction factor can be represented as the density of the adhesive.

By means of these two measured variables, the leakage time and the correction factor for the mass calculation, it is possible to precisely calculate the mass delivered to ±7%.

The two measurements of the leakage time and of the correction factor are repeated as soon as production is carried out with a modified temperature setting or with some other liquid medium/some other type of adhesive to enable the desired accuracy of the calculation of ±7% to be maintained.

If the air pressure for driving the piston pump changes, this effect can be readily compensated by a suitable calculation. This calculation is performed, in particular, empirically. As a result, there is no need for recalibration when there is a change in the air pressure of the piston pump.

The leakage times and correction factors determined are preferably stored in an appropriate manner for each type of adhesive and temperature to enable them to be reused for subsequent production under comparable conditions without the need for redetermination. It would also be possible for a data field to be determined and stored in advance for each type of adhesive so that the user is not hindered by matching procedures during production.

In order to generate additional utility, it would be possible to detect wear of the piston pump in the event of large deviations in the currently measured leakage times from the stored values.

The measurement of the leakage time can be performed automatically before the beginning of a production process. Users can program the time of day of the end and the beginning of their production process. A melting unit for melting the adhesive is then switched on at the right time before the specified start of production to ensure that the operating temperature is achieved before the start of production. The controller could be programmed in such a way that it is switched on somewhat earlier to enable the leakage time to be measured automatically before the start of production when the operating temperature is achieved. Users would then notice nothing of this measuring process. Until measurement of the leakage time was complete, there would be no production clearance for a higher-level controller. It should also be possible for measurement of the leakage time to be started manually by the operator.

If only the end positions of the piston pump can be measured, intermediate positions of the piston cannot be determined accurately. As a remedy for a lower resolution of the metered quantity of adhesive, it is possible to use the time which has passed since the last changeover. This normally enables an intermediate position of the piston and of the quantity of adhesive thereby delivered to be interpolated with sufficient accuracy.

Even greater accuracy in the determination of the applied quantity of adhesive for each product processed can be achieved if the piston position of the pump is measured.

In particular, it is envisaged that reversal positions of a piston of the piston pump and/or intermediate positions of the piston between the reversal points thereof are detected by means of Hall effect sensors.

The effectively delivered volume V_{eff} and/or the mass m delivered is preferably calculated on the basis of a knowledge of the position of the piston.

Calculation of the applied mass of adhesive in the manner described above represents a particularly simple possibility. With little additional outlay, made up largely of the outlay for the software, it is possible to generate additional utility for the user. The retrofitting of the measurement of the adhesive application can be implemented easily and with little outlay.

In particular, it is envisaged that the medium delivered during the delivery of the effectively delivered volume V_{eff} is determined in terms of its mass m, and the density D of the medium is calculated in accordance with

$$D = \frac{m}{{V}_{eff}}$$

As the medium is being delivered to the consumer, the delivered mass of the medium is preferably calculated continuously by multiplying the volume calculated according to the above method by the decisive density D.

In particular, the method steps are repeated after each change of the temperature settings of the medium to be delivered to the consumer and/or after each change of the liquid medium, in particular of the heated adhesive, and/or each change of the pressure acting on the drive of the piston pump. In particular, the leakage times t_{L auf} and t_{L ab} and/or a total leakage time t_{Leck} are/is measured before the beginning of production, in particular automatically before the beginning of production.

In particular, leakage times and/or correction factors are stored for each type of medium, in particular type of adhesive, and temperature, for the purpose of use in subsequent production processes under comparable conditions without the need for redetermination.

In particular, the leakage times t_{L auf} and t_{L ab} or the total leakage time t_{Leck} thereof measured for the output pressure are/is corrected by means of a calculation model based on tests if there is a change in the pressure on the drive of the piston pump.

A fault message, in particular a fault message relating to wear of the piston pump, is output if large deviations in the currently measured leakage times from stored values of the leakage times are detected.

The piston pump which is used in the method according to the invention and in the developments of this method is designed, in particular, as a double acting, pneumatically drivable piston pump, having a piston embodied in such a way that it does not form a seal with respect to a cylinder, having a piston rod embodied in such a way that it does not form a seal with respect to a guide, and having two check valves, wherein one check valve is open and the other check valve is closed, depending on the direction of movement of the piston.

In particular, the check valves are of different designs.

Further objects, aspects, features and advantages of the invention are provided in the following detailed description of exemplary embodiments, the brief description of the drawing figures and the accompanying drawing figures themselves, wherein it should be noted that all the individual features and all the combinations of individual features are applicable to the invention.

### BRIEF DESCRIPTION OF THE DRAWING FIGURES

The invention is illustrated in the accompanying drawing figures by means of exemplary embodiments without being restricted thereto.

FIG. 1 shows an application unit for hot melt adhesive, having an adhesive tank and an adhesive pump installed in said tank.

FIG. 2 shows the adhesive pump shown in FIG. 1 in a sectional illustration, having an overflow channel.

FIG. 3 shows the illustration of the partial area of the piston pump during an upward piston stroke.

FIG. 4 shows the illustration of the partial area of the piston pump during a downward piston stroke.

FIG. 5 shows a diagram intended to illustrate the leakage behavior of the double acting, pneumatically driven piston pump as the piston moves from the bottom dead center position into the top dead center position and from the top dead center position into the bottom dead center position (leakage volume as a function of the stroke time).

FIG. 6 shows a diagram intended to illustrate the measured leakage times as a function of the pressure acting on the drive of the piston pump, illustrated for different heated adhesives, and thus different viscosities of the liquid medium, wherein curves are calculated from the measured points.

### DETAILED DESCRIPTION OF EXEMPLARY EMBODIMENTS

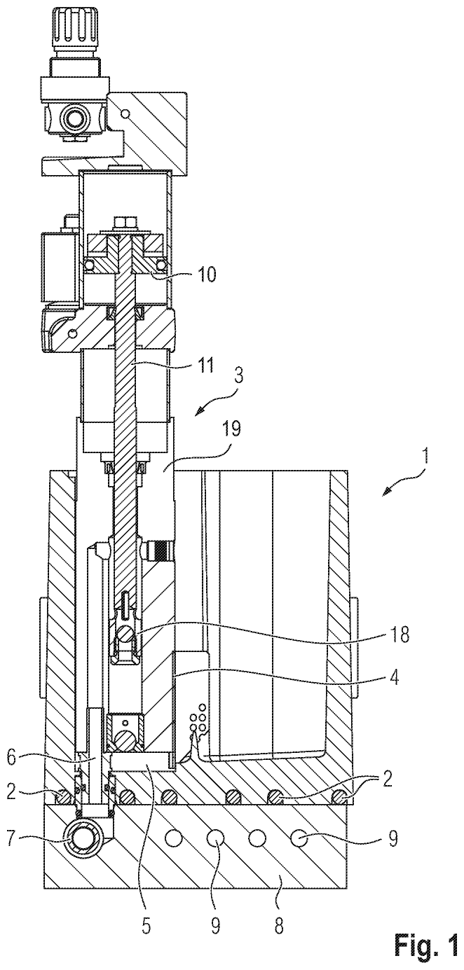

FIG. 1 shows an adhesive tank 1 for holding a viscous hot melt adhesive, e.g. one based on EVA. Heating elements 2 of the adhesive tank 1 serve to heat up the adhesive, causing it to melt and allowing it to be brought to its processing temperature. A piston pump 3 is inserted into the adhesive tank 1 and secured thereto. The piston pump 3 is a double acting pump, and thus a pump which acts in both stroke directions of the piston. The piston pump 3 is driven pneumatically. Arranged in the inflow region of the adhesive from the adhesive tank 1 to the piston pump 3 there is a perforated plate 4 to retain incompletely melted solid adhesive. The adhesive passes through the holes in the perforated plate 4 into an intake chamber 5 for adhesive below the piston pump 3. From there, the adhesive is drawn into the piston pump 3 and discharged under pressure via a pressure port 6. Downstream of the pressure port 6 there is an adhesive filter 7. From there, adhesive passes into a pressure distributor 8 leading to outlets 9 for adhesive consumers. As used herein, the term “consumers” is intended to refer generically to adhesive application equipment that receives the adhesive, for example, an adhesive applicator module, adhesive dispenser, applicator nozzle or the like.

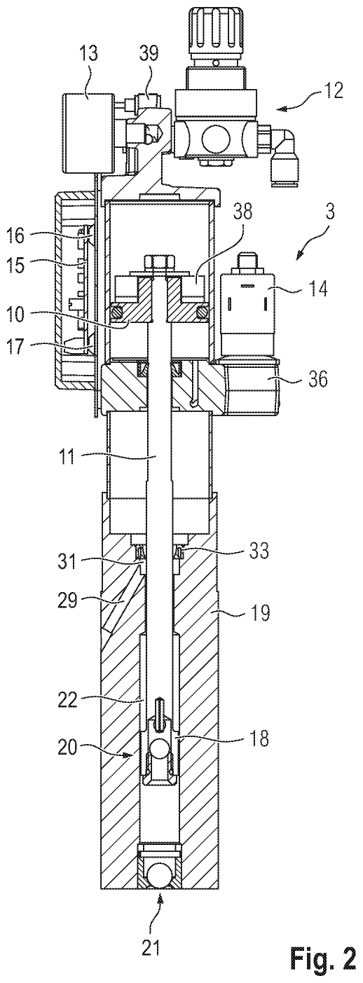

FIG. 2 shows the design of the piston pump 3. This has an upper pneumatic part having a piston 10 for the drive. The piston 10 is connected in a fixed manner to a piston rod 11, which forms the active element for delivering the adhesive under pressure. This pneumatic region of the piston pump 3 furthermore has a pressure distributor 36 for pneumatics for driving the pump, a manually adjustable pressure regulator 12, a manometer 13, a solenoid valve 14, an annular magnet 38 and a pressure sensor 39. The pressure sensor 39 is used to measure the air pressure P acting on the drive of the piston pump 3. The pressure sensor 39 is installed downstream of the pressure regulator 12. The pressure sensor 39 is required for automatic correction calculation in the case of a change in the air pressure P. Two Hall effect sensors 16, 17 are used to determine the piston position at the reversal points of the piston and the intermediate positions thereof. With the aid of the piston position, it is possible to calculate the volume delivered by the piston pump and the mass delivered, to increase the accuracy or resolution of the calculation.

An electronic system of the piston pump 3 furthermore has an electronic print 15 without a processor.

Outside the pneumatic part of the piston pump 3 and thus in the adhesive delivery region of the piston pump 3, this has a widened portion in the region of the end of the piston rod 11 remote from the piston 10, said widened portion forming a double acting piston 18. The piston 18 is provided with an axial passage 28, in the region of which the check valve 20 with associated valve seat is arranged. Furthermore, passage openings 30 for adhesive are provided at the transition of the piston 18 to the reduced-diameter region of the piston rod 11. The piston 18 is guided without forming a seal in a cylinder bore 22 formed in a housing 19 or cylinder of the adhesive delivery region. In this region, the piston pump 3 furthermore has an upper check valve 20 and a lower check valve 21. The lower check valve 21 is arranged in the intake chamber 5, with the result that adhesive can enter the adhesive delivery chamber of the piston pump 3 from the intake chamber 5, past the check valve 21, when the check valve 21 is in a defined position. If the upper check valve 20 is in a defined position, adhesive can pass the check valve 20 to the pressure port 6 and, from there, can reach the outlets 9 for the adhesive consumers.

A dynamic seal 33 is provided without differential pressure between the pneumatic part and the adhesive-delivering part of the piston pump 3.

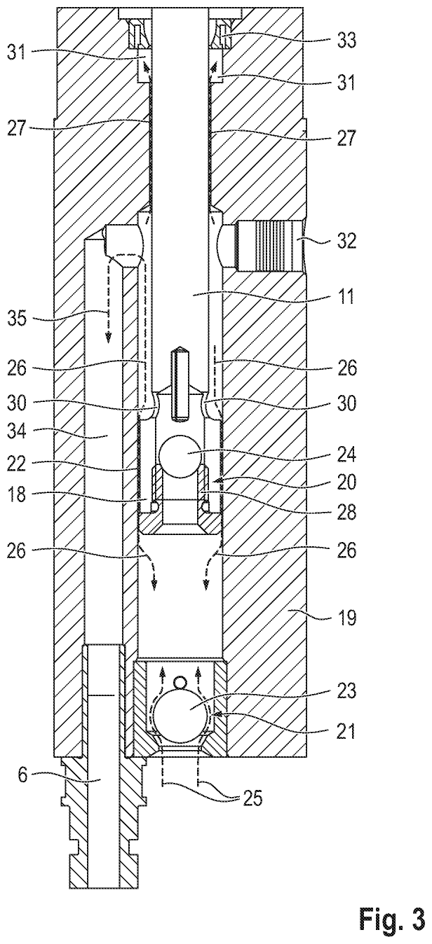

FIG. 3 shows the situation as the piston 10 is transferred from the bottom dead center position to the top dead center position. Owing to the force and flow conditions, a ball 23 of the lower check valve 21 has risen from the ball seat thereof, and a ball 24 of the other check valve 20 is in contact with the ball seat associated with this ball 24. Consequently, adhesive can be drawn out of the adhesive tank 1 in the direction of the arrows 25 and passes through the check valve 21, which is in the open position, into the cylinder chamber of the adhesive delivery region of the piston pump 3, while, owing to the upward stroke movement of the piston 18, adhesive is discharged in accordance with arrows 35 through a laterally arranged pressure channel 34 and the pressure port 6 following the latter in the flow direction. During this upward movement of the piston 18, a leakage flow in accordance with the arrows 26 forms in the annular gap between the piston 18 and the housing 19 because of the non-sealing arrangement of the piston 18 and the wall interacting therewith in the region of the cylinder bore 22. In the outflowing region of the adhesive, leakage furthermore arises between the piston rod 11 and the housing 19 as illustrated by the arrows 27 into a chamber 31 of the housing 19 further up, in which ambient pressure prevails. This chamber 31 is connected to an overflow channel 29, which thus serves to allow the overflow of leakage between the piston rod 11 and the housing 19. This leakage is returned to the adhesive tank 1 via the overflow channel 29.

During the stroke of the piston rod 11 and hence of the pistons 10 and 18 from the bottom dead center position to the top dead center position, adhesive is thus simultaneously delivered to the outlets 9 and adhesive is drawn in from the adhesive tank 1. Leakage losses occur between the piston rod 11 and the housing 19 and between the piston 18 and the housing 19.

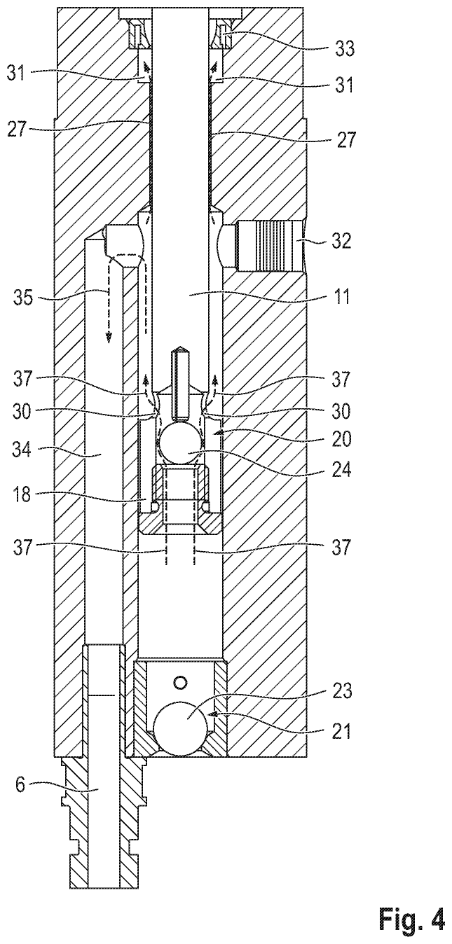

FIG. 4 illustrates the conditions during the movement of the piston rod 11 in the opposite direction and thus during the movement of the piston rod 11 and hence of the pistons 10 and 18 from the top dead center position to the bottom dead center position. During this process, only adhesive delivery occurs. No adhesive is drawn in from the adhesive tank 1. The adhesive flows upward through the passage 28 of the piston 18 in accordance with arrow 37, through the passage openings 30 into the annular chamber between the piston rod 11 and the housing 19 and, from there, through the pressure channel 34 to the outlets 9 in accordance with arrow 35. Leakage losses occur only between the piston rod 11 and the housing 19. The flow between the pistons 18 and the housing 19 has no effect on the quantity of adhesive delivered.

More specifically, the ball 23 is in its lower position on contact with the ball seat during this movement of the piston rod 11 from the top down, and therefore inflow from the adhesive tank 1 is not possible. The adhesive flows upward on the inside of the piston 18. The ball 24 of the upper check valve 20 is raised from the ball seat, with the result that adhesive is delivered to the pressure port 6 through the passage openings 30. Leakage in accordance with the arrows 27 occurs between the piston rod 11 and the housing 19 and thus between the pressure chamber and chamber 31, in which ambient pressure prevails.

Reference numeral 32 indicates a closure plug.

After each change in the temperature setting and after each change of adhesive, the following procedure is repeated in accordance with a preferred approach. In this case, the following process is carried out at constant pressure, which acts on the pneumatic drive of the piston pump.
1. Without the piston pump being able to supply adhesive to the consumer, the time t_{L auf} for one complete stroke of the piston pump from the bottom dead center position to the top dead center position is measured. This time t_{L auf} is referred to as the leakage time for the upward movement of the piston.
2. Without the piston pump being able to supply adhesive to the consumer, the time t_{L ab} for one complete stroke of the piston pump from the top dead center position to the bottom dead center position is measured. This time t_{L ab} is referred to as the leakage time for the downward movement of the piston.
3. The total leakage time t_{Leck} for one complete double stroke of the piston is obtained by adding the two leakage times for the upward stroke t_{L auf} and the downward stroke t_{L ab}.
4. For the upward stroke, the ratio m_{auf} of the volume delivered to the time for one complete stroke movement from the bottom dead center position to the top dead center position is determined. For this purpose, the volume V_{auf} theoretically delivered without leakage is divided by the leakage time t_{L auf}.
5. For the downward stroke, the ratio m_{ab} of the volume delivered to the time for one complete stroke movement from the top dead center position to the bottom dead center position is determined. For this purpose, the volume V_{ab} theoretically delivered without leakage is divided by the leakage time t_{L ab}.
6. During operation and thus during the delivery of the medium to the consumer, the elapsed time is measured for each complete stroke movement of the piston pump. For the stroke from the bottom dead center position to the top dead center position, the time t_{auf} is determined. For the stroke from the top dead center position to the bottom dead center position, the time t_{ab} is determined.
7. The effectively delivered volume V_{eff} is calculated by subtracting the ratio m_{auf} multiplied by the time t_{auf} from the theoretical delivery volume V_{auf} for each upward stroke and by subtracting the ratio m_{ab} multiplied by the time t_{ab} from the theoretical delivery volume V_{ab} for each downward stroke.
8. During any time period t, adhesive is delivered and collected in a collecting container. During this time period t, the effectively delivered adhesive volume V_{eff} is calculated in accordance with the above method. The mass m of adhesive collected is measured on a balance. From this, the density D is determined by dividing the mass m delivered by the effectively delivered volume V_{eff}.
9. During the operation of the piston pump, the mass delivered is calculated continuously by multiplying the volume V_{eff} calculated in accordance with the above method by the density D.

It is possible to store the values determined from the calibration procedures in a data matrix relative to the temperature settings, the type of adhesive and the viscosity of the adhesive to avoid the need to carry out a recalibration process after each change.

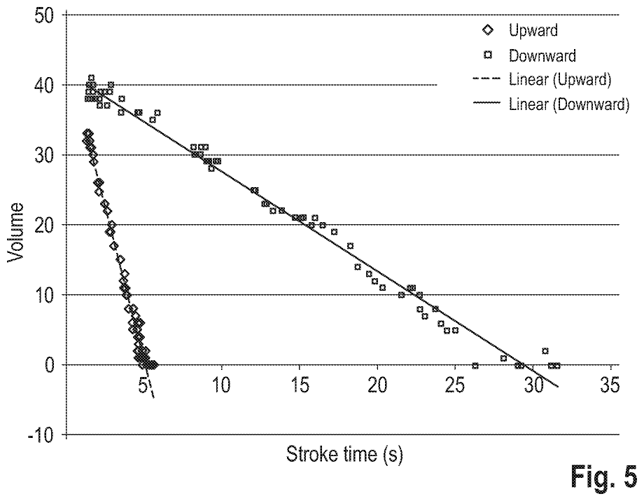

FIG. 5 shows how the leakage time for the double stroke is divided between the time for the upward stroke and the time for the downward stroke in the case of the piston pump used. The times for the two stroke movements are different in magnitude. The effectively delivered volume for each stroke direction can be calculated in a simple manner by means of linear relationships, using these two times. In the left-hand, steeper graph, FIG. 5 shows the measurement points for the upward movement of the piston. For the movement from the bottom dead center position to the top dead center position, the piston requires about 5 seconds at a leakage volume of somewhat more than forty units. For the movement from the top dead center position to the bottom dead center position, a significantly longer time is required, namely almost 30 seconds, as illustrated by the measurement points situated along the less steeply sloping line.

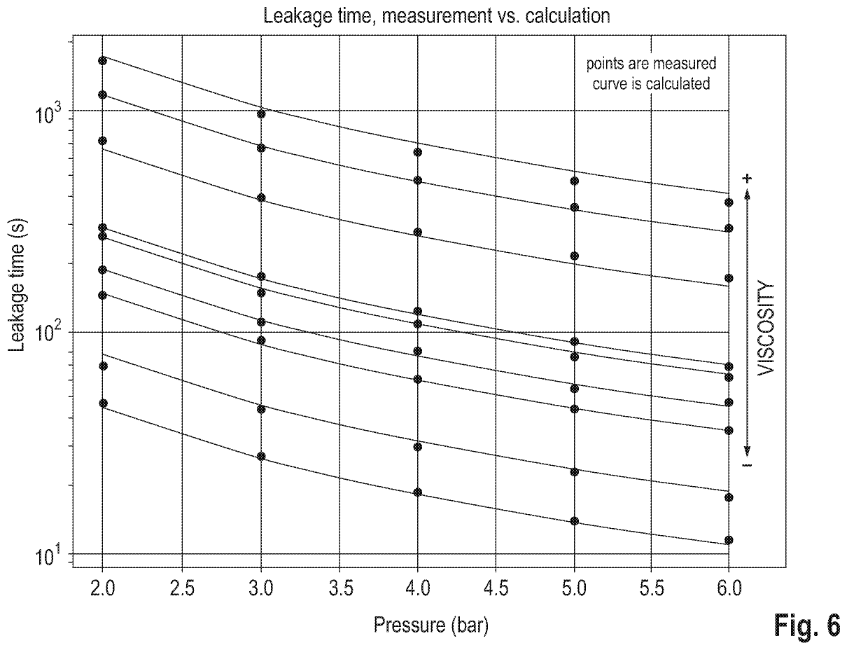

FIG. 6 shows various curves for measurements when using adhesives of different viscosities, wherein each curve signifies one viscosity. The lowermost curve illustrates the conditions at the lowest viscosity, and the respective curves situated above it illustrate adhesives of higher viscosity. For each curve, the leakage time is indicated in seconds as a function of the pressure P acting on the piston 10 of the drive. The points shown in FIG. 6 are measured, while the curves are calculated.

Taking into account the above steps 1 to 9, a calculation model can be used when the pressure P acting on the piston pump is changed. The calculation process compensates the effect of the pressure P on the quantity of adhesive delivered. For this purpose, the measured leakage times t_{L auf} and t_{L ab} are corrected. The new corrected leakage times, in turn, are used as input values for the above calculation method. The calculation model can be developed on the basis of a large number of tests and is tailored to a particular piston pump. Different specific values apply for other pumps.

The mass of adhesive is thus determined in two steps. First of all, the calculated leakage is used to determine the volume of adhesive delivered per unit time and the number of products processed. In a second step, the mass is determined with a previously determined density of the adhesive. It is thus necessary to determine information on the leakage and density before the mass delivered can be calculated. This approach enables the user to know the mass of adhesive applied per product.

That which is claimed is:

1. A method for determining a volume V_{eff} of a liquid medium delivered to a consumer by a double acting, pneumatically driven piston pump, wherein the piston pump is subject to leakage when a constant pressure is acting on a drive of the piston pump and at least one double stroke of a piston pump from one dead center position thereof to the other dead center position thereof and back to the first dead center position is carried out, comprising:
a. without the piston pump being able to deliver the medium to the consumer, a leakage time t_{L auf} for one stroke of the piston pump from the bottom dead center position thereof to the top dead center position thereof is measured;
b. without the piston pump being able to deliver the medium to the consumer, a leakage time t_{L ab} for one stroke of the piston pump from the top dead center position thereof to the bottom dead center position thereof is measured;
c. a quotient of a volume of the medium V_{auf} theoretically delivered by the piston pump without leakage and of the leakage time t_{L auf} is determined for the stroke of the piston pump from the bottom dead center position to the top dead center position;
d. a quotient of a volume V_{ab} theoretically delivered by the piston pump without leakage and of the leakage time t_{L ab} is determined for the stroke of the piston pump from the top dead center position to the bottom dead center position;
e. the time t_{auf} for the stroke of the piston pump from the bottom dead center position to the top dead center position and the time t_{ab} for the stroke of the piston pump from the top dead center position to the bottom dead center position is measured as the medium is delivered to the consumer; and
f. the effectively delivered volume V_{eff} is multiplied by the number of double strokes in accordance with
$${V}_{eff} = ( {V}_{auf} - \frac{{V}_{auf}}{{t}_{L auf}} \times {t}_{auf} ) + ( {V}_{ab} - \frac{{V}_{ab}}{{t}_{L ab}} \times {t}_{ab} ) .$$

2. The method as claimed in claim 1, wherein the volume V_{eff} of the medium delivered is determined in terms of its mass m, and the density D of the medium is calculated in accordance with
$$D = \frac{m}{{V}_{eff}} .$$

3. The method as claimed in claim 2, wherein, as the medium is being delivered to the consumer, the delivered mass of the medium is calculated continuously by multiplying the calculated delivered volume V_{eff} by the density D.

4. The method as claimed in claim 1, wherein the steps are repeated after each change of the temperature settings of the medium to be delivered to the consumer and/or after each change of the medium and/or after each change of the pressure acting on the drive of the piston pump.

5. The method as claimed in claim 1, wherein the leakage times t_{L auf} and t_{L ab} and/or a total leakage time t_{Leck} are/is measured before the beginning of production.

6. The method as claimed in claim 1, wherein the leakage times and/or the densities are stored for each type of medium and temperature, for the purpose of use in subsequent production processes under comparable conditions without the need for redetermination.

7. The method as claimed in claim 1, wherein the leakage times t_{L auf} and t_{L ab} and/or a total leakage time t_{Leck} thereof measured for the output pressure are/is corrected by means of a calculation model based on tests if there is a change in the pressure on the drive of the piston pump.

8. The method as claimed in claim 1, wherein a message relating to wear of the piston pump is output if a large deviation in a currently measured leakage time from a stored value of the leakage times is detected.

9. The method as claimed in claim 1, wherein reversal positions of a piston of the piston pump and/or intermediate positions of the piston between the reversal points thereof are detected by means of Hall effect sensors.

10. The method as claimed in claim 9, wherein the delivered volume and/or the delivered mass are/is calculated on the basis of a knowledge of the position of the piston.

11. A double acting, pneumatically drivable piston pump for carrying out the method as claimed in claim 1, having a piston configured in such a way that it does not form a seal with respect to a cylinder, having a piston rod configured in such a way that it does not form a seal with respect to a guide, and having two check valves, wherein one check valve is open and the other check valve is closed, depending on the direction of movement of the piston.

12. The piston pump as claimed in claim 11, wherein the check valves are of different designs.
